(19) United States
(12) Patent Application Publication
(10) Pub. No.: US 2026/0188224 A1
(43) Pub. Date: Jul. 2, 2026

(54) PIXEL, DISPLAY DEVICE, AND ELECTRONIC DEVICE INCLUDING THE SAME

(71) Applicant: Samsung Display Co., Ltd., Yongin-si (KR)

(72) Inventors: JUNHYUN PARK, Yongin-si (KR); HWA-RANG LEE, Yongin-si (KR); NAHYEON CHA, Yongin-si (KR)

(21) Appl. No.: 19/391,716

(22) Filed: Nov. 17, 2025

(30) Foreign Application Priority Data
Dec. 31, 2024 (KR) 10-2024-0202232

(51) Int. Cl. G09G 3/3233

(52) U.S. Cl. CPC G09G 3/3233; G09G 2300/0819; G09G 2300/0852; G09G 2300/0861; G09G 2310/08; G09G 2330/028

(57) ABSTRACT

A pixel includes: a light emitting element connected between a first power supply voltage terminal and a second power supply voltage terminal; a first transistor connected between the first power supply voltage terminal and the light emitting element; a second transistor connected between a data line and a first node; a storage capacitor connected between the first node and a gate terminal of the first transistor; and a holding capacitor connected between the first node and an anode initialization voltage terminal.

### CROSS-REFERENCE TO RELATED APPLICATION

The present application claims priority to and the benefit of Korean Patent Application No. 10-2024-0202232, filed on December 31, 2024, in the Korean Intellectual Property Office, the entire disclosure of which is incorporated herein by reference.

### BACKGROUND

### Field

Aspects of some embodiments of the present disclosure relate to a pixel, a display device, and an electronic device including the same.

### Description of the Related Art

A pixel emits light based on data voltage and includes a transistor (e.g., a thin-film transistor (TFT)) that controls the driving of the pixel. A display device may display an image using a sequential emission method, in which pixels emit light sequentially on a row-by-row basis, or a simultaneous emission method, in which all pixels emit light simultaneously after the sequential completion of data writing.

The above information disclosed in this Background section is only for enhancement of understanding of the background and therefore the information discussed in this Background section does not necessarily constitute prior art.

### SUMMARY

Aspects of some embodiments of the present disclosure include a pixel, a display device, and an electronic device including the same. Aspects of embodiments according to the present disclosure are not limited to the foregoing, and other unmentioned characteristics of embodiments of the present disclosure will be understood from the following description and be more clearly understood from the embodiments of the present disclosure. In addition, it will be appreciated that the characteristics of embodiments according to the present disclosure can be implemented by means provided in the claims and a combination thereof.

According to some embodiments of the present disclosure, a pixel includes: a light emitting element connected between a first power supply voltage terminal and a second power supply voltage terminal; a first transistor connected between the first power supply voltage terminal and the light-emitting element; a second transistor connected between a data line and a first node; a storage capacitor connected between the first node and a gate terminal of the first transistor; and a holding capacitor connected between the first node and an anode initialization voltage terminal.

According to some embodiments, the second transistor may be turned on or off according to a write scan signal.

According to some embodiments, the pixel may further include: a third transistor connected between a drain terminal of the first transistor and a first terminal of the storage capacitor and configured to be turned on or off according to a compensation scan signal; and a fourth transistor connected between the first node and a reference voltage terminal and configured to be turned on or off according to the compensation scan signal.

According to some embodiments, the pixel may further include a fifth transistor connected between the first power supply voltage terminal and the first transistor and configured to be turned on or off according to an emission control signal.

According to some embodiments, the compensation scan signal applied to the third transistor and the fourth transistor may be an n-th compensation scan signal, and the pixel may further include a sixth transistor connected between the first power supply voltage terminal and the first terminal of the storage capacitor and configured to be turned on or off according to a (n-k)-th compensation scan signal.

According to some embodiments, a compensation period may be adjusted based on a value of k.

According to some embodiments, the pixel may further include a seventh transistor connected between an anode of the light emitting element and the anode initialization voltage terminal and configured to be turned on or off according to an initialization scan signal.

According to some embodiments, during a first period, the seventh transistor may be turned on and an anode initialization voltage may be applied to the anode of the light emitting element.

According to some embodiments, during a first period, the sixth transistor may be turned on and a first power supply voltage may be applied to the gate terminal of the first transistor.

According to some embodiments, during a second period, the third transistor and the fourth transistor may be turned on, a first power supply voltage may be applied to a drain terminal of the first transistor, and a reference voltage may be applied to the first node.

According to some embodiments of the present disclosure, there is provided a display device including: a display unit including a plurality of pixels; a scan driver configured to supply a corresponding scan signal to each of the plurality of pixels through a plurality of scan lines; an emission control driver configured to supply a corresponding emission control signal to each of the plurality of pixels through a plurality of emission control lines; a data driver configured to supply a corresponding data voltage to each of the plurality of pixels through the plurality of data lines; and a power supply configured to supply a first power supply voltage, a second power supply voltage, and an anode initialization voltage to each of the plurality of pixels, wherein each of the plurality of pixels comprises a light emitting element connected between a first power supply voltage terminal, to which the first power supply voltage is applied, and a second power supply voltage terminal, to which the second power supply voltage is applied; a first transistor connected between the first power supply voltage terminal and the light emitting element; a second transistor connected between the corresponding data line and the first node; a storage capacitor connected between the first node and a gate terminal of the first transistor; and a holding capacitor connected between the first node and the anode initialization voltage terminal to which the anode initialization voltage is applied.

According to some embodiments, the scan signal may include a write scan signal, and the second transistor may be turned on or off according to the write scan signal.

According to some embodiments, the scan signal may include a compensation scan signal, the power supply may be configured to supply a reference voltage, and each of the plurality of pixels may further include: a third transistor connected between a drain terminal of the first transistor and a first terminal of the storage capacitor and configured to be turned on or off according to the compensation scan signal; and a fourth transistor connected between the first node and a reference voltage terminal, to which the reference voltage is applied, and configured to be turned on or off according to the compensation scan signal.

According to some embodiments, each of the plurality of pixels may further include a fifth transistor connected between the first power supply voltage terminal and the first transistor and configured to be turned on or off according to the emission control signal.

According to some embodiments, the compensation scan signal applied to the third transistor and the fourth transistor may be an N-th compensation scan signal, and each of the plurality of pixels may further include a sixth transistor connected between the first power supply voltage terminal and the first terminal of the storage capacitor and configured to be turned on or off according to a (N-K)-th compensation scan signal.

According to some embodiments, a compensation period may be adjusted based on a value of K.

According to some embodiments, the scan signal may include an initialization scan signal, and each of the plurality of pixels may further include a seventh transistor connected between an anode of the light emitting element and the anode initialization voltage terminal and configured to be turned on or off according to the initialization scan signal.

According to some embodiments, during a first period, the seventh transistor may be turned on and the anode initialization voltage may be applied to the anode of the light emitting element.

According to some embodiments, during a first period, the sixth transistor may be turned on and the first power supply voltage may be applied to the gate terminal of the first transistor.

According to some embodiments, the power supply may be configured to supply a reference voltage, and during a second period, the third transistor and the fourth transistor may be turned on, the first power supply voltage may be applied to a drain terminal of the first transistor, and the reference voltage may be applied to the first node.

According to some embodiments of the present disclosure, there is provided an electronic device including: a memory; a processor configured to execute an application stored in the memory; and a display module configured to process a signal transmitted from the processor and output image information, wherein the display module comprises a plurality of pixels, and each of the plurality of pixels includes: a light emitting element connected between a first power supply voltage terminal and a second power supply voltage terminal; a first transistor connected between the first power supply voltage terminal and the light emitting element; a second transistor connected between a data line and the first node; a storage capacitor connected between the first node and a gate terminal of the first transistor; and a holding capacitor connected between the first node and an anode initialization voltage terminal.

According to some embodiments, the second transistor may be turned on or off according to a write scan signal.

According to some embodiments, each of the plurality of pixels may further include: a third transistor connected between a drain terminal of the first transistor and a first terminal of the storage capacitor and configured to be turned on or off according to a compensation scan signal; and a fourth transistor connected between the first node and a reference voltage terminal and configured to be turned on or off according to the compensation scan signal.

According to some embodiments, each of the plurality of pixels may further include a fifth transistor connected between the first power supply voltage terminal and the first transistor and configured to be turned on or off according to an emission control signal.

According to some embodiments, the compensation scan signal applied to the third transistor and the fourth transistor may be an n-th compensation scan signal, and each of the plurality of pixels may further include a sixth transistor connected between the first power supply voltage terminal and the first terminal of the storage capacitor and configured to be turned on or off according to a (n-k)-th compensation scan signal.

According to some embodiments, a compensation period may be adjusted based on a value of k.

According to some embodiments, each of the plurality of pixels may further include a seventh transistor connected between an anode of the light emitting element and the anode initialization voltage terminal and configured to be turned on or off according to an initialization scan signal.

According to some embodiments, during a first period, the seventh transistor may be turned on and an anode initialization voltage may be applied to the anode of the light emitting element.

According to some embodiments, during a first period, the sixth transistor may be turned on and a first power supply voltage may be applied to the gate terminal of the first transistor.

According to some embodiments, during a second period, the third transistor and the fourth transistor may be turned on, a first power supply voltage may be applied to a drain terminal of the first transistor, and a reference voltage may be applied to the first node.

The above and other aspects, features, and characteristics will become apparent from the following detailed description and claims in conjunction with the accompanying drawings.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a display device according to some embodiments of the present disclosure;

FIG. 2 is a circuit diagram illustrating a structure of a pixel;

FIG. 3 is a circuit diagram illustrating a structure of a pixel according to some embodiments of the present disclosure;

FIG. 4 is a timing diagram of signals for driving the pixel shown in FIG. 3 during a first scan period;

FIG. 5 is a circuit diagram for describing the operation of the elements of the pixel shown in FIG. 3 during the first period;

FIG. 6 is a circuit diagram for describing the operation of the elements of the pixel shown in FIG. 3 during a second period;

FIG. 7 is a circuit diagram for describing the operation of the elements of the pixel shown in FIG. 3 during a third period;

FIG. 8 is a circuit diagram for describing the operation of the elements of the pixel shown in FIG. 3 during a fourth period;

FIG. 9 is a circuit diagram for describing the operation of the elements of the pixel shown in FIG. 3 during a fifth period; and

FIG. 10 is a timing diagram of signals for driving the pixel shown in FIG. 3 during the second scan period.

FIG. 11 is a circuit diagram illustrating a structure of a pixel according to some embodiments of the present disclosure.

FIG. 12 is a block diagram illustrating an electronic device according to some embodiments.

FIG. 13 illustrates schematic diagrams of electronic devices according to various embodiments.

### DETAILED DESCRIPTION

As the disclosure allows for various changes and numerous embodiments, particular embodiments will be shown in the drawings and described in detail in the written description. The effects and features of the present disclosure and a method for accomplishing them will be described more fully with reference to the accompanying drawings, in which embodiments of the present disclosure are shown. This invention may, however, be embodied in many different forms and should not be construed as limited to the embodiments set forth herein.

It will be understood that although the terms “first,” “second,” etc., may be used herein to describe various components, these components should not be limited by these terms. These terms are only used to distinguish one component from another.

As used herein, the singular forms “a” and “an” are intended to include the plural forms as well, unless the context clearly indicates otherwise.

It will be further understood that the terms “comprises/includes” and/or “comprising/including” used herein specify the presence of stated features or components, but do not preclude the presence or addition of one or more other features or components.

It will be understood that when a unit, region, or component is referred to as being “formed on” another layer, region, or component, it can be directly or indirectly formed on the other layer, region, or component, and intervening units, regions, or components may be present.

It will be understood that when an element is referred to as being “connected” or “coupled” to another element, it can be directly connected or coupled to the other element or intervening elements may be present, unless the context clearly indicates otherwise.

In the drawings, the sizes of components may be exaggerated or reduced for convenience of explanation. In other words, since sizes and thicknesses of components in the drawings are arbitrarily illustrated for convenience of explanation, the following embodiments are not limited thereto.

Hereinafter, aspects of some embodiments of the present disclosure will be described below in more detail with reference to the accompanying drawings. Those components that are the same or are in correspondence are rendered the same reference numeral regardless of the figure number, and some redundant explanations may be omitted.

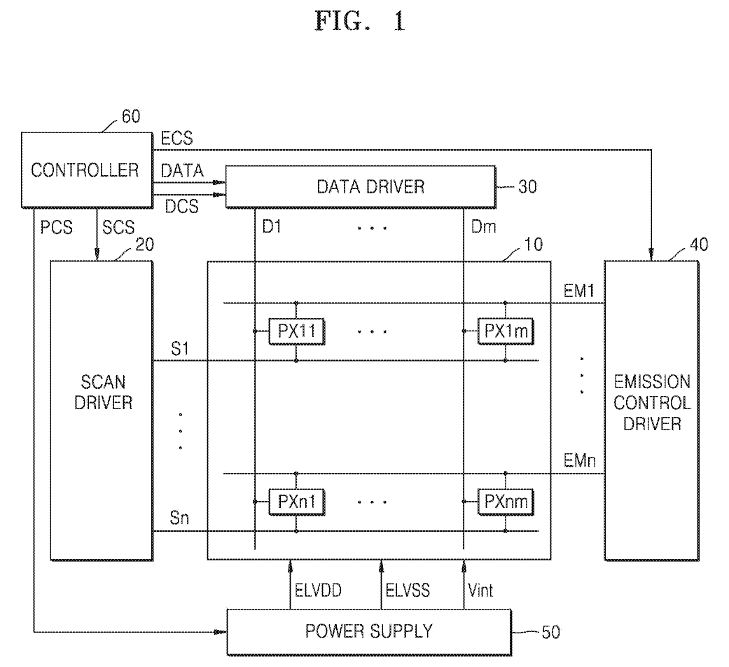

FIG. 1 is a block diagram illustrating a display device according to some embodiments of the present disclosure.

Referring to FIG. 1, a display device according to some embodiments of the present disclosure may include a display unit 10 including a plurality of pixels PX11 to PXnm, a scan driver 20, a data driver 30, an emission control driver 40, a power supply 50, and a controller 60.

According to some embodiments, the display unit 10 is connected to a plurality of scan lines S1 to Sn, a plurality of emission control lines EM1 to EMn, and a plurality of data lines D1 to Dm, and the plurality of pixels PX11 to PXnm may be respectively connected to one or more corresponding scan lines among the plurality of scan lines S1 to Sn, one or more corresponding emission control lines among the plurality of emission control lines EM1 to EMn, and one or more corresponding data lines among the plurality of data lines D1 to Dm.

According to some embodiments, although not explicitly shown in the display unit 10 of FIG. 1, the plurality of pixels PX11 to PXnm may be respectively connected to a plurality of power supply lines connected to the display unit 10 and may receive power for its operation, such as a first power supply voltage ELVDD, a second power supply voltage ELVSS, and an initialization voltage Vint.

According to some embodiments, the display unit 10 may include a plurality of pixels PX11 to PXnm arranged in a selectable form, for example, in a matrix form.

According to some embodiments, each of the plurality of pixels PX11 to PXnm may emit light with a preset luminance corresponding to a driving current supplied to a light emitting element according to a corresponding data voltage transmitted through the plurality of data lines D1 to Dm.

According to some embodiments, the display unit 10 may be referred to as a “display panel.” In the disclosure, the display panel may be implemented as one of, for example, a liquid crystal display (LCD), a light emitting diode (LED) display, an organic LED (OLED) display, an active-matrix OLED (AMOLED) display, an Electrochromic Display (ECD), a Digital Mirror Device (DMD), an Actuated Mirror Device (AMD), a Grating Light Value (GLV), a Plasma Display Panel (PDP), an Electro Luminescent Display (ELD), a Vacuum Fluorescent Display (VFD), or any other type of flat panel display or flexible display.

According to some embodiments, the scan driver 20 may generate and transmit scan signals corresponding to the respective pixels through the plurality of scan lines S1 to Sn. That is, the scan driver 20 may transmit the scan signal through the corresponding scan line to each of a plurality of pixels included in each row. For example, the scan driver 20 may receive a scan driving control signal SCS from the controller 60, generate a plurality of scan signals, and sequentially supply the scan signals to the plurality of scan lines S1 to Sn that are connected to the respective rows.

According to some embodiments, the scan driver 20 may generate and supply one or more types of scan signals. For example, the scan driver 20 may generate and supply scan signals required according to the pixel implementation method or emission control method, such as a first scan signal (or write scan signal) GW, a second scan signal G) (or initialization scan signal), a third scan signal GB (or bypass scan signal), and a fourth scan signal GC (compensation scan signal). Accordingly, the scan lines S1 to Sn may include one or more types of scan lines, and a certain type of scan lines may be configured for each scan signal. For example, the first scan signal GW may be applied to each of the plurality of pixels PX11 to PXnm through a plurality of first scan lines GWL1 to GWLn, the second scan signal GI may be applied through the plurality of second scan lines GIL1 to GILn, the third scan signal GB may be applied through a plurality of third scan lines GBL1 to GBLn, and the fourth scan signal GC may be applied through a plurality of fourth scan lines (GCL1 to GCLn).

According to some embodiments, the data driver 30 may transmit data signals to each pixel through a plurality of data lines D1 to Dm. For example, the data driver 30 may receive a data driving control signal DCS from the controller 60 and supply data signals corresponding to the plurality of data lines D1 to Dm that are respectively connected to a plurality of pixels PX11 to PXnm included in the respective rows.

According to some embodiments, the emission control driver 40 may be connected to a plurality of emission control lines EM1 to EMn connected to the display unit 10 that includes a plurality of pixels PX11 to PXnm arranged in a matrix form. That is, a plurality of emission control lines EM1 to EMn that extend parallel (or substantially parallel) to each other while opposing the plurality of pixels in a row direction connect the plurality of pixels and the emission control driver 40.

According to some embodiments, the emission control driver 40 may generate an emission control signal corresponding to each pixel through the plurality of emission control lines EM1 to EMn and transmit the same to the corresponding pixel. Each pixel which has received the emission control signal may be controlled to emit an image according to an image data signal in response to the control of the emission control signal. That is, the operation of the emission control transistor included in each pixel may be controlled in response to the emission control signal transmitted through the corresponding emission control line, and accordingly, the light emitting element connected to the emission control transistor may or may not emit light with a luminance according to the driving current corresponding to the data signal.

According to some embodiments, two emission control signals may be supplied to each pixel. That is, the emission of one pixel may be controlled based on two types of emission control signals.

According to some embodiments, the power supply 50 may supply a first power supply voltage ELVDD, a second power supply voltage ELVSS, an initialization voltage Vint, an anode initialization voltage VAINT, an on-bias voltage VOBS, etc. to each pixel of the display unit 10. For example, the first power supply voltage ELVDD may be a high level voltage, and the second power supply voltage ELVSS may be a voltage lower than the first power supply voltage ELVDD, or a ground voltage. For example, the initialization voltage Vint may be set to a voltage value that is equal to or lower than the second power supply voltage ELVSS.

According to some embodiments, the voltage values of the first power supply voltage ELVDD, the second power supply voltage ELVSS, and the initialization voltage Vint are not particularly limited, but the voltage values may be set or controlled according to the control of the power control signal PCS transmitted from the controller 60.

According to some embodiments, the controller 60 may convert a plurality of image signals transmitted from the outside into a plurality of image data signals DATA and transmit the same to the data driver 30. In addition, the controller 60 may receive a vertical synchronization signal Vsync, a horizontal synchronization signal Hsync, and a clock signal MCLK, and generate control signals for controlling the scan driver 20, the emission control driver 40, and the data driver 30, and transmits the control signals to the same. That is, the controller 60 may generate a scan driving control signal SCS for controlling the scan driver 20, an emission driving control signal ECS for controlling the operation of the emission control driver 40, and a data driving control signal DCS for controlling the data driver 30, and transmit the generated control signal to the corresponding driver. Additionally, the controller 60 may generate the power control signal PCS for controlling the operation of the power supply 50 and transmit the same to the power supply 50.

According to some embodiments, the display device may further include a reference voltage generator. For example, the reference voltage generator may generate a reference voltage VRef based on the control signal received from the controller 60. The reference voltage generator may provide the reference voltage VRef to the data driver 30. The reference voltage VRef may have a value corresponding to each data signal DATA. According to some embodiments, the reference voltage generator may be placed within the controller 60 or within the data driver 30.

According to some embodiments, the data driver 30 may receive a data driving control signal DCS from the controller 60 and may receive the reference voltage VRef from the reference voltage generator. The data driver 30 may convert the data signal DATA into an analog data voltage VDATA using the reference voltage VRef. For example, the data driver 30 may output the data voltage VDATA to the data line.

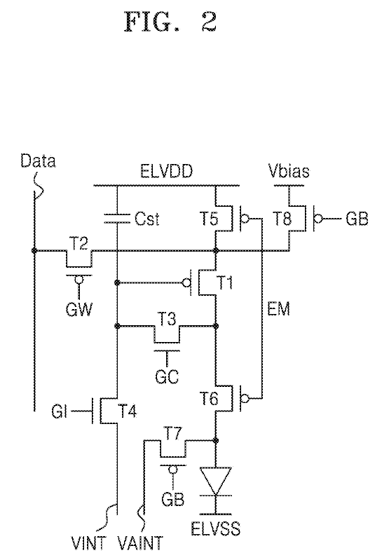

FIG. 2 is a circuit diagram illustrating a structure of a pixel. Although FIG. 2 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 2, a pixel may include a light emitting element and a pixel circuit for controlling emission or non-emission of the light emitting element. The pixel circuit shown in FIG. 2 may include eight transistors T1 to T8 and one capacitor Cst.

In the pixel shown in FIG. 2, the number of transistors included in the pixel circuit is large, and various signals need to be applied to control the operation of a plurality of transistors, so limitations related to a resolution limit may become problematic.

In response to this, to relatively improve image quality characteristics, the process for the driving transistor is modified (e.g., oxide TFT), and a pixel circuit based on this modification is designed (e.g., 6T2C structure). However, the addition of a holding capacitor Chold may relatively reduce integration density, introduce a compensation error during the data writing process, or decrease the transmission rate of the data voltage, leading to increased power consumption.

Various embodiments of the present disclosure may provide a pixel circuit, a pixel, a display device, or an electronic device that can overcome the aforementioned drawbacks.

A pixel circuit according to some embodiments of the present disclosure may include a first transistor connected between a first power supply voltage terminal and a light emitting element, a second transistor connected between a data line and a first node, a storage capacitor connected between the first node and a gate terminal of the first transistor, and a holding capacitor connected between the first node and an anode initialization voltage terminal. A pixel according to some embodiments of the present disclosure may include a pixel circuit according to some embodiments and a light emitting element connected between a first power supply voltage terminal and a second power supply voltage terminal. Hereinafter, the pixel circuit and pixel according to the disclosure will be described in detail.

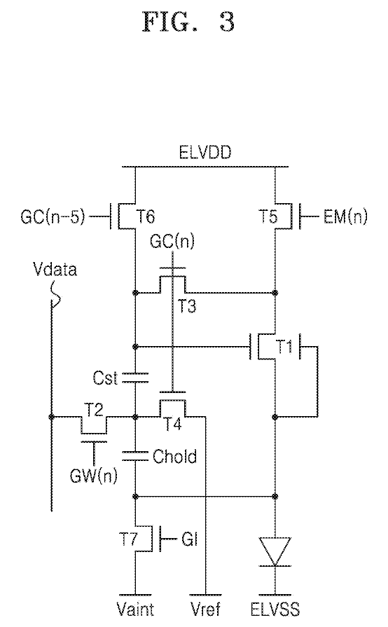

FIG. 3 is a circuit diagram illustrating a structure of a pixel according to some embodiments of the present disclosure. Although FIG. 3 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 3, a pixel according to some embodiments of the present disclosure may include a light emitting element and a pixel circuit for controlling the emission or non-emission of the light emitting element. Referring to FIG. 3, the pixel according to some embodiments of the present disclosure may include seven transistors T1 to T7 and two capacitors Cst and Chold.

The pixel according to some embodiments of the present disclosure may include a first transistor T1 connected between a first power supply voltage terminal and a light emitting element. Referring to FIG. 3, the first transistor T1 is shown, which is turned on or off according to a signal applied to its gate terminal (or upper gate terminal) and controls the current for the emission of the light emitting element. The first transistor T1 may also be referred to as a “driving transistor.” According to some embodiments, the gate terminal of the first transistor T1 may be connected to a first terminal of a first capacitor (or storage capacitor) Cst. According to some embodiments, a second terminal of the first transistor T1 may be connected to an anode of the light emitting element. Additionally, according to some embodiments, the second terminal of the first transistor T1 may be connected to a lower gate terminal of the first transistor T1. Here, the first transistor T1 may be an N-type metal oxide semiconductor field effect transistor (MOSFET), the first terminal of the first transistor T1 may be a drain terminal, and the second terminal of the first transistor T1 may be a source terminal, but the embodiments are not limited thereto.

The pixel according to some embodiments of the present disclosure may include a second transistor T2 connected between a data line and a first node. Referring to FIG. 3, in the pixel according to some embodiments of the present disclosure, the second transistor T2 is shown, which is turned on or off according to a signal applied to its gate terminal and controls the supply of a data voltage Vdata. According to some embodiments, the gate terminal of the second transistor T2 may be connected to a first scan signal (or write scan signal) GW(n). According to some embodiments, a first terminal of the second transistor T2 may be connected to a data line that supplies a data voltage Vdata, while a second terminal of the second transistor T2 may be connected to a second terminal of the first capacitor Cst. Here, the second transistor T2 may be an N-type MOSFET, the first terminal of the second transistor T2 may be a drain terminal, and the second terminal of the second transistor T2 may be a source terminal, but the embodiments are not limited thereto.

The pixel according to some embodiments of the present disclosure may further include a third transistor T3 that is connected between the drain terminal of the first transistor T1 and a first terminal of the storage capacitor Cst and is turned on or off according to a fourth scan signal (or compensation scan signal) GC(n). Referring to FIG. 3, in the pixel according to some embodiments of the present disclosure, the third transistor T3 may be turned on or off according to a fourth scan signal GC(n). According to some embodiments, a first terminal of the third transistor T3 may be connected to the gate terminal of the first transistor T1, while a second terminal of the third transistor T3 may be connected to the first terminal of the first transistor T1. Here, the third transistor T3 may be an N-type MOSFET, the first terminal of the third transistor T3 may be a drain terminal, and the second terminal of the third transistor T3 may be a source terminal, but the embodiments are not limited thereto.

The pixel according to some embodiments of the present disclosure may further include a fourth transistor T4 that is connected between the first node and a reference voltage terminal and is turned on or off according to a fourth scan signal GC(n). Referring to FIG. 3, in the pixel according to some embodiments of the present disclosure, the fourth transistor T4 may be turned on or off according to a fourth scan signal GC(n). According to some embodiments, a first terminal of the fourth transistor T4 may be connected to the reference voltage terminal that supplies a reference voltage Vref, while a second terminal of the fourth transistor T4 may be connected to the second terminal of the second transistor T2. Here, the fourth transistor T4 may be an N-type MOSFET, the first terminal of the fourth transistor T4 may be a drain terminal, and the second terminal of the fourth transistor T4 may be a source terminal, but the embodiments are not limited thereto.

The pixel according to some embodiments of the present disclosure may further include a fifth transistor T5 that is connected between the first power supply voltage terminal and the first transistor T1 and is turned on or off according to an emission control signal EM(n). Referring to FIG. 3, in the pixel according to some embodiments of the present disclosure, the fifth transistor T5 may be turned on or off according to the emission control signal Em(n). According to some embodiments, a first terminal of the fifth transistor T5 may be connected to the first power supply voltage terminal that supplies a first power supply voltage ELVDD, while a second terminal of the fifth transistor T5 may be connected to the first terminal of the first transistor T1. Here, the fifth transistor T5 may be an N-type MOSFET, the first terminal of the fifth transistor T5 may be a drain terminal, and the second terminal of the fifth transistor T5 may be a source terminal, but the embodiments are not limited thereto.

The pixel according to some embodiments of the present disclosure may further include a sixth transistor T6 that is connected between the first power supply voltage terminal and the first terminal of the first capacitor Cst and is turned on or off according to the (n-k)-th fourth emission control signal GC(n-5). Referring to FIG. 3, in a pixel according to some embodiments of the present disclosure, the sixth transistor T6 may be turned on or off according to a preceding fourth scan signal GC(nk). According to some embodiments, a first terminal of the sixth transistor T6 may be connected to the first power supply voltage terminal that supplies the first power supply voltage ELVDD, while a second terminal of the sixth transistor T6 may be connected to the gate terminal of the first transistor T1. Here, the sixth transistor T6 may be an N-type MOSFET, the first terminal of the sixth transistor T6 may be a drain terminal, and the second terminal of the sixth transistor T6 may be a source terminal, but the embodiments are not limited thereto.

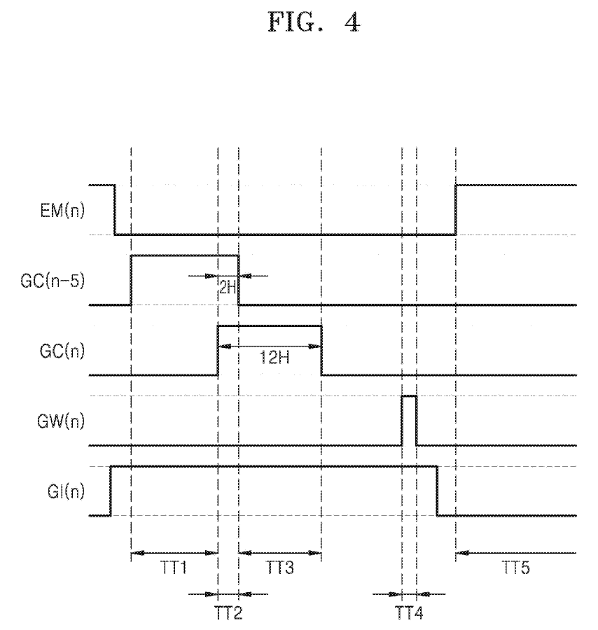

Here, the preceding fourth scan signal GC(n-k) may precede the fourth scan signal GC(n) by k times a reference period, and in the example shown in FIG. 3, k is 5. The fourth scan signal GC(n) may be the n-th fourth scan signal, and the preceding fourth scan signal GC(n-5) may be the (n-5)-th fourth scan signal. For example, in the example shown in FIG. 3, the preceding fourth scan signal GC(n-5) may precede the fourth scan signal GC(n) by five times the reference period, and a specific example of the preceding fourth scan signal GC(n-5) will be described further below with reference to FIG. 4.

The pixel according to some embodiments of the present disclosure may further include a seventh transistor T7 that is connected between the anode of the light emitting element and the anode initialization voltage terminal and is turned on or off according to a second scan signal (or initialization scan signal) GI(n). Referring to FIG. 3, in the pixel according to some embodiments of the present disclosure, the seventh transistor T7 may be turned on or off according to the second scan signal GI(n). According to some embodiments, a first terminal of the seventh transistor T7 may be connected to the anode initialization voltage terminal that supplies an anode initialization voltage Vaint, while a second terminal of the seventh transistor T7 may be connected to the anode of the light emitting element. Here, the seventh transistor T7 may be an N-type MOSFET, the first terminal of the seventh transistor T7 may be a drain terminal, and the second terminal of the seventh transistor T7 may be a source terminal, but the embodiments are not limited thereto.

The pixel according to some embodiments of the present disclosure may include the first capacitor Cst connected between the first node and the gate terminal of the first transistor. Referring to FIG. 3, in the pixel according to some embodiments of the present disclosure, the first capacitor Cst may be connected between the gate terminal of the first transistor T1 and the second terminal of the second transistor T2.

The pixel according to some embodiments of the present disclosure may include a second capacitor Chold connected between the first node and the anode initialization voltage terminal. Referring to FIG. 3, in the pixel according to some embodiments of the present disclosure, the second capacitor (or holding capacitor) Chold may be connected between the second terminal of the second transistor T2 and the second terminal of the seventh transistor T7.

Referring to FIG. 3, in the pixel according to some embodiments of the present disclosure, the anode of a light emitting element may be connected to the second terminal of the first transistor T1, while a cathode of the light emitting element may be connected to the second power supply voltage terminal to which the second power supply voltage ELVSS is applied.

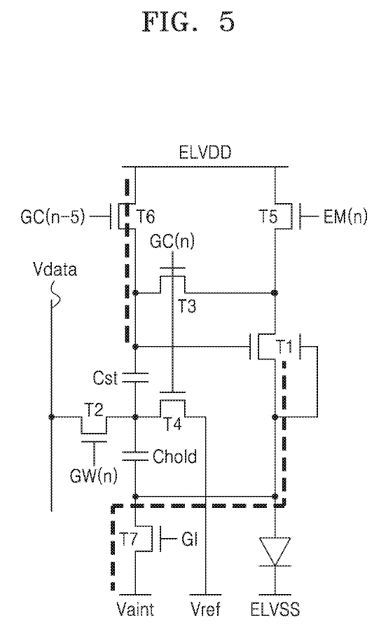

The characteristics or effects of the pixel according to some embodiments of the present disclosure, as shown in FIG. 3, may become more apparent from the detailed description of the operation provided with reference to FIGS. 5 to 10.

FIG. 4 is a timing diagram of signals for driving the pixel shown in FIG. 3 during a first scan period.

According to some embodiments, a frame that may correspond to a single unit period may include a first scan period and a second scan period. For example, a frame may include one first scan period and one or more second scan periods. The first scan period may refer to an address scan period, while the second scan period may refer to a self-scan period. The timing diagram shown in FIG. 4 may correspond to the first scan period.

Referring to FIG. 4, the changes over a certain period in the signals applied to the pixel in FIG. 3 are shown, including the emission control signal EM(n), the first scan signal GW(n), the second scan signal GI(n), the fourth scan signal GC(n), and the preceding fourth scan signal GC(n-5).

As can be seen from FIGS. 3 and 4, unlike the conventional pixel, the pixel circuit according to the disclosure may not require a third scan signal GB to be applied.

Referring to FIG. 4, the first scan period may largely include a first period TT1, a second period TT2, a third period TT3, a fourth period TT4, and a fifth period TT5. The first period TT1 may be understood as an initialization period, during which a gate terminal of a driving transistor of the pixel (e.g., the first transistor T1 shown in FIG. 3) is initialized and the anode of the light emitting element is also initialized. The second period TT2 may be understood as a pre-compensation period, and the third period TT3 may be understood as a compensation period. During the second period TT2 and the third period TT3, voltages may be applied to the capacitors and a threshold voltage Vth may be compensated. The fourth period TT4 may be understood as a data writing period, during which a data voltage for representing the brightness of the light emitting element is applied. The fifth period TT5 may be understood as an emission period, in which a current is applied to the light emitting element, causing it to emit (or not emit) light.

Hereinafter, with reference to FIGS. 5 to 9, the operation in each section of the pixel according to some embodiments of the present disclosure, as shown in FIG. 3, will be described. In FIGS. 5 to 9, sections that are electrically connected and through which signals are transmitted are indicated by dotted lines.

FIG. 5 is a circuit diagram for describing the operation of the elements of the pixel shown in FIG. 3 during the first period.

Referring to the values of signals in the first period TT1 of FIG. 4, it is shown that the preceding fourth scan signal GC(n-5) applied to the gate terminal of the sixth transistor T6 of FIG. 3 and the second scan signal GI(n) applied to the gate terminal of the seventh transistor T7 have high voltages. As a result, the sixth transistor T6 and the seventh transistor T7 may be turned on. The first period TT1 may be understood as an initialization period.

Referring to FIG. 5, when the sixth transistor T6 is turned on, the first power supply voltage ELVDD supplied to the first terminal (e.g., the drain terminal) of the sixth transistor T6 may be applied to the gate terminal of the first transistor T1. Accordingly, the voltage applied to the gate terminal of the first transistor T1 may be ELVDD.

Referring to FIG. 5, when the seventh transistor T7 is turned on, the anode initialization voltage Vaint supplied to the first terminal (e.g., the drain terminal) of the seventh transistor T7 may be applied to the anode of the light emitting element (or the second terminal of the first transistor T1). Accordingly, the voltage applied to the anode of the light emitting element may be Vaint.

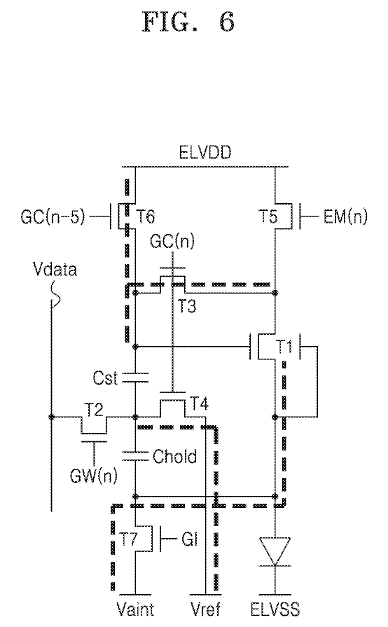

FIG. 6 is a circuit diagram for describing the operation of the elements of the pixel shown in FIG. 3 during the second period.

Referring to the values of signals in the second period TT2 of FIG. 4, it is shown that the preceding fourth scan signal GC(n-5) applied to the gate terminal of the sixth transistor T6 of FIG. 3, the fourth scan signal GC(n) applied to the third transistor T3 and the fourth transistor T4, and the second scan signal GI(n) applied to the gate terminal of the seventh transistor T7 have high voltages. As a result, the third transistor T3, the fourth transistor T4, the sixth transistor T6, and the seventh transistor T7 may be turned on. The second period TT2 may be understood as a pre-compensation period.

Referring to FIG. 6, when the third transistor T3 is turned on, the first power supply voltage may be applied to the first terminal (e.g., the drain terminal) of the first transistor T1.

Referring to FIG. 6, when the fourth transistor T4 is turned on, the reference voltage Vref supplied to the first terminal (e.g., the drain terminal) of the fourth transistor T4 can be applied to the second terminal (e.g., the source terminal) of the second transistor T2. Accordingly, the voltage applied to the second terminal of the second transistor T2, i.e., the node between the first capacitor Cst and the second capacitor Chold, may be Vref.

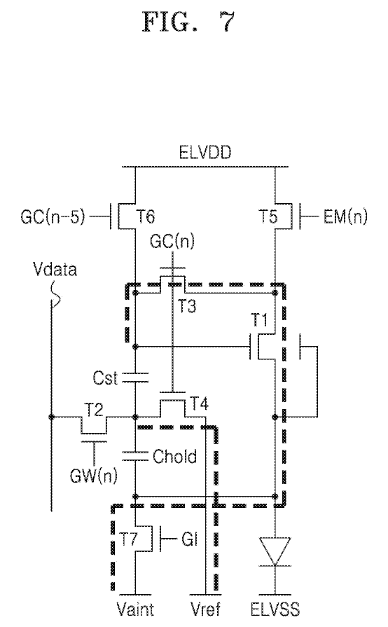

FIG. 7 is a circuit diagram for describing the operation of the elements of the pixel shown in FIG. 3 during the third period.

Referring to the values of signals in the third period TT3 of FIG. 4, it is shown that the preceding fourth scan signal GC(n-5) applied to the gate terminal of the sixth transistor T6 of FIG. 3 is changed to a low voltage, and the fourth scan signal GC(n) applied to the gate terminals of the third transistor T3 and the fourth transistor T4, and the second scan signal GI(n) applied to the gate terminal of the seventh transistor T7 have high voltages. As a result, the sixth transistor T6 may be turned off, and the third transistor T3, the fourth transistor T4, and the seventh transistor T7 may be turned on. The third period TT3 may be understood as a compensation period.

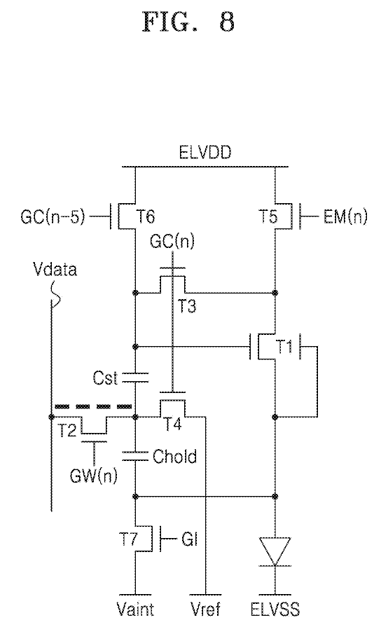

FIG. 8 is a circuit diagram for describing the operation of the elements of the pixel shown in FIG. 3 during the fourth period.

Referring to the values of signals in the fourth period TT4 of FIG. 4, it is shown that the first scan signal GW(n) applied to the gate terminal of the second transistor T2 of FIG. 3 and the second scan signal GI(n) applied to the gate terminal of the seventh transistor T7 have high voltages. As a result, the second transistor T2 and the seventh transistor T7 may be turned on. The fourth period TT4 may be understood as a writing period.

Referring to FIG. 8, when the second transistor T2 is turned on, the data voltage Vdata supplied to the first terminal (e.g., the drain terminal) of the second transistor T2 may be applied to the second terminal (e.g., the source terminal) of the second transistor T2, i.e., the node between the first capacitor Cst and the second capacitor Chold.

In the pixel according to some embodiments of the present disclosure, due to the arrangement of the first capacitor Cst, a threshold voltage Vth of the first transistor T1 may be stored in the first capacitor Cst, thereby isolating it from the source terminal of the first transistor T1. As a result, a compensation error during data writing may be eliminated.

As described above, in the example shown in FIGS. 3 and 4, the preceding fourth scan signal GC(n-5) may precede the fourth scan signal GC(n) by five times the reference period. According to some embodiments, the compensation period may be adjusted based on k which represents the extent to which the preceding fourth scan signal (GC(n-k)) precedes the fourth scan signal GC(n). For example, when k is 6, that is, when the sixth transistor T6 is turned on or off according to the (n-6)-th fourth scan signal GC(n-6), the second period TT2 decreases and the third period TT3 increases, thereby increasing the compensation period.

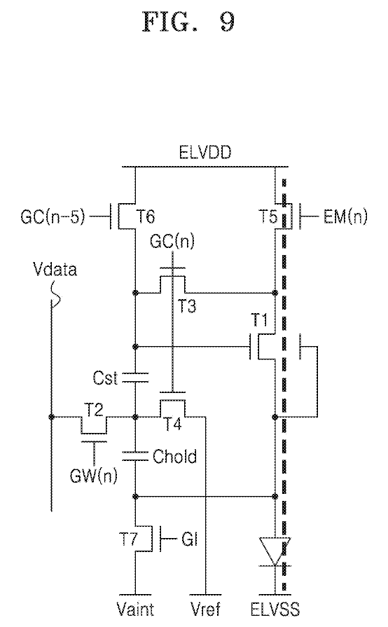

FIG. 9 is a circuit diagram for describing the operation of the elements of the pixel shown in FIG. 3 during the fifth period.

Referring to the values of signals in the fifth period TT5 of FIG. 4, it is shown that the preceding fourth scan signal GC(n-5), the fourth scan signal GC(n), the first scan signal GW(n), and the second scan signal GI(n) have low voltages, while the emission control signal EM(n) has a high voltage. As a result, the fifth transistor T5 may be turned on, while the second transistor T2, the third transistor (T3), the fourth transistor T4, the sixth transistor T6, and the seventh transistor T7 may be turned off. The fifth period TT5 may be understood as an emission period.

Referring to FIG. 9, when the fifth transistor T5 is turned on, the first power supply voltage ELVDD supplied to the first terminal (e.g., the drain terminal) of the fifth transistor T5 may be applied to the first terminal (e.g., the drain terminal) of the first transistor T1. Accordingly, a driving current may flow through the first transistor T1, and the driving current may be applied to the light emitting element, causing it to emit light.

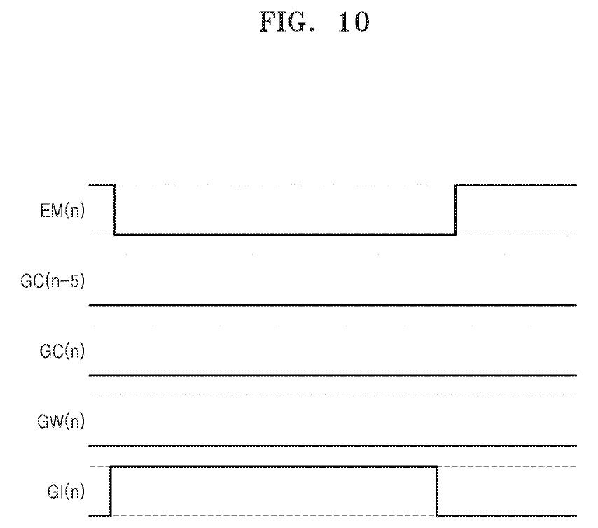

FIG. 10 is a timing diagram of signals for driving the pixel shown in FIG. 3 during the second scan period.

As described above, a frame that may correspond to a single unit period may include the first scan period and the second scan period. The first scan period may refer to an address scan period, and the second scan period may refer to a self-scan period. The timing diagram shown in FIG. 10 may correspond to the second scan period.

Referring to FIG. 10, during the second scan period, the first scan signal GW(n), the fourth scan signal GC(n), and the preceding fourth scan signal GC(n-5) may be maintained at low voltages. Referring to FIG. 10, the second scan period may include a period during which the second scan signal GI(n) has a high voltage, and a period during which the emission control signal EM(n) has a high voltage.

During the period in which the second scan signal GI(n) has a high voltage, the seventh transistor T7 of the present disclosure may be turned on, and the initialization voltage Vaint may be applied to the anode of the light emitting element.

During the period in which the emission control signal Em(n) has a high voltage, the fifth transistor T5 of the present disclosure may be turned on, and the first power supply voltage ELVDD may be applied to the first terminal (e.g., the drain terminal) of the first transistor T1. However, since the data voltage Vdata is not applied to the gate terminal of the first transistor T1, a driving current may not be generated.

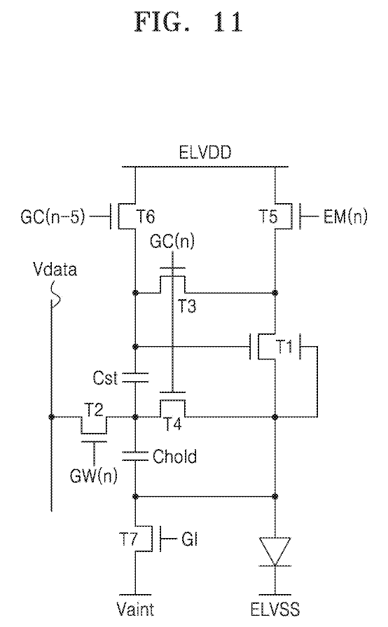

FIG. 11 is a circuit diagram illustrating a structure of a pixel according to some embodiments of the present disclosure. Although FIG. 11 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 11, a pixel according to some embodiments of the present disclosure may include a light emitting element and a pixel circuit for controlling the emission or non-emission of the light emitting element. Referring to FIG. 11, the pixel according to some embodiments of the present disclosure may include seven transistors T1 to T7 and two capacitors Cst and Chold.

Compared to the pixel shown in FIG. 3, the pixel shown in FIG. 11 may differ in that the first terminal of the fourth transistor T4 is not connected to the reference voltage terminal that supplies the reference voltage Vref, but instead is connected to the second terminal of the first transistor T1.

Accordingly, in the pixel shown in FIG. 11, during the second period TT2 and the third period TT3 of FIG. 4, the initialization voltage Vaint, rather than the reference voltage Vref, may be applied to the second terminal (e.g., source terminal) of the second transistor T2. Except for this difference, the operation of the pixel according to the embodiments shown in FIG. 3, as described above with reference to FIGS. 4 to 10, may be applied in the same manner to the operation of the pixel shown in FIG. 11.

In the pixel according to the embodiments described above, each of the second transistor T2, the third transistor T3, the fourth transistor T4, the fifth transistor T5, the sixth transistor T6, and the seventh transistor is described as being an N-type MOSFET, but according to some embodiments, at least some of the second transistor T2, the third transistor T3, the fourth transistor T4, the fifth transistor T5, the sixth transistor T6, and the seventh transistor T7 may be P-type MOSFETs.

Additionally, according to some embodiments, a scan signal applied to a gate signal of the sixth transistor T6 may be individually provided and applied. For example, according to some embodiments, the sixth transistor T6 may be turned on or off according to a fifth scan signal applied to the gate signal of the sixth transistor T6. According to some embodiments, the fifth scan signal may be the second scan signal GI.

The pixel circuit or display device according to various embodiments of the present disclosure may be applied to various electronic devices. An electronic device according to some embodiments may include the aforementioned pixel circuit or display device, and may further include modules or devices with additional functions, in addition to the pixel circuit or display device.

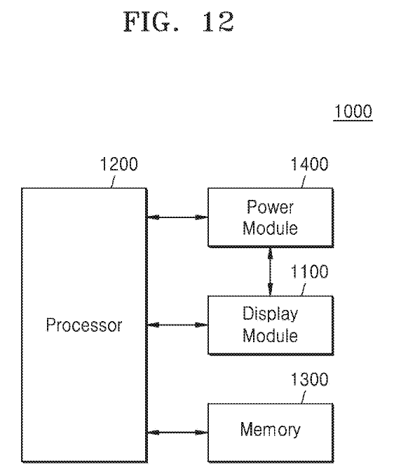

FIG. 12 is a block diagram illustrating an electronic device according to some embodiments.

Referring to FIG. 12, an electronic device 1000 according to some embodiments may include a display module 1100, a processor 1200, a memory 1300, and a power module 1400.

The processor 1200 may include at least one of a central processing unit CPU, an application processor AP, a graphics processing unit (GPU), a communication processor CP, an image signal processor ISP, or a controller.

Data information necessary for the operation of the processor 1200 or display module 1100 may be stored in the memory 1300. When the processor 1200 executes an application stored in the memory 1300, an image data signal and/or an input control signal may be transmitted to the display module 1100, and the display module 1100 may process the received signal and output image information through a display screen.

The power module 1400 may include a power supply module, such as a power adapter or a battery device, and a power conversion module that converts power supplied by the power supply module to generate power required for the operation of the electronic device 1000.

At least one of the components of the above-described electronic device 1000 may be included in the display device according to the embodiments described above. Additionally, some individual modules that are functionally included in a single module may be partially included in the display device, while others may be provided separately from the display device. For example, the display device may include the display module 1100, while the processor 1200, the memory 1300, and the power module 1400 may be provided as other devices within the electronic device 1000, rather than within the display device.

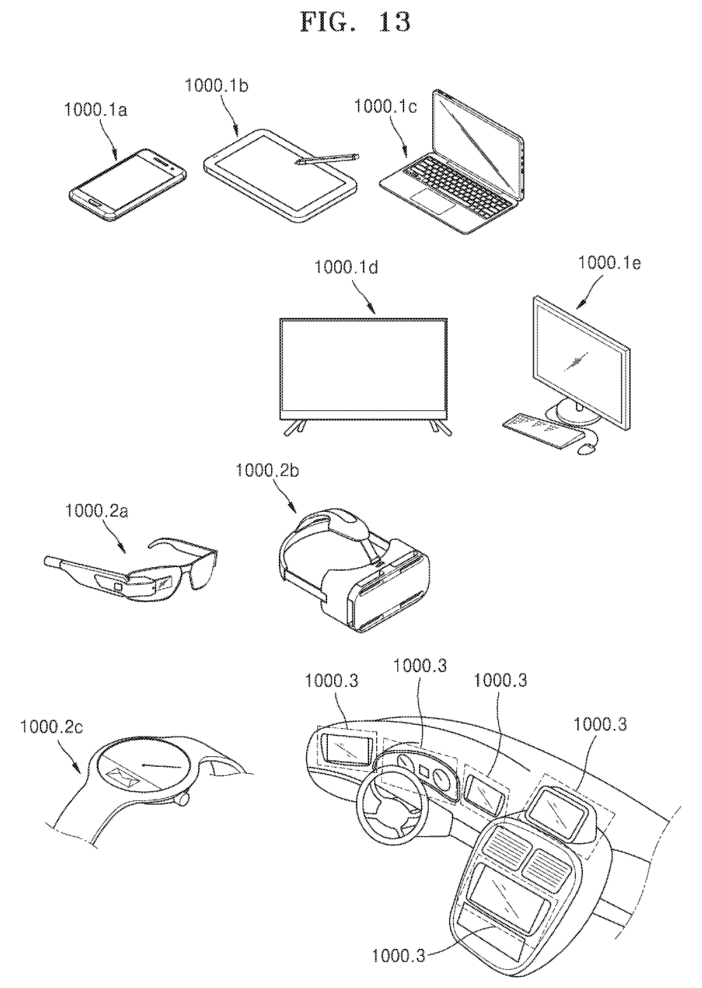

FIG. 13 illustrates schematic diagrams of electronic devices according to various embodiments.

Referring to FIG. 13, various electronic devices to which display devices according to embodiments are applied may include not only image display electronic devices such as a smart phone 1000.1a, a tablet PC 1000.1b, a laptop computer 1000.1c, a TV 1000.1d, and a desk monitor 1000.1e, but also wearable electronic devices including a display module, such as smart glasses 1000.2a, a head mounted display 1000.2b, and a smart watch 1000.2c, and vehicle electronic devices 1000.3 including a display module, such as a room mirror display, and a center information display (CID) arranged on an instrument panel, a center fascia, or a dashboard of a vehicle.

According to various embodiments of the present disclosure, the number of signals applied to the pixel may be relatively reduced, which may relatively improve integration density or relatively reduce signal interference, ultimately relatively improving image quality characteristics.

It will be appreciated by one of ordinary skill in the art that the effects that can be achieved with the disclosure are not limited to what has been particularly described hereinabove and other characteristics of embodiments according to the present disclosure will be more clearly understood from the following description taken in conjunction with the accompanying drawings.

The embodiments described above may be implemented independently; however, it is evident that the structures of the various embodiments may also be applied in combination with one another.

Although the disclosure has been described with reference to the embodiments illustrated in the drawings, these embodiments are merely examples. One of ordinary skill in the art will understand that various modifications and equivalent embodiments will be apparent from this description. Accordingly, the inventive concept is not limited to such embodiments, but rather to the broader scope of the presented claims and various obvious modifications and equivalent arrangements.

The particular implementations shown and described herein are illustrative examples of the embodiments and are not intended to otherwise limit the scope of the embodiments in any way. Moreover, no element is essential for implementation of the embodiments unless the element is specifically described as “essential” or “critical”.

The use of the terms “a” and “an” and “the” and similar referents in the context of describing the present invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. Embodiments of the present disclosure are not limited to the described order of the operations. The use of any and all examples, or example language (e.g., “such as”) provided herein, is intended merely to better illuminate the disclosure and does not pose a limitation on the scope of the present disclosure unless otherwise claimed. Numerous modifications and adaptations will be readily apparent to one of ordinary skill in the art without departing from the spirit and scope of the present disclosure.

What is claimed is:

1. A pixel comprising:
a light emitting element connected between a first power supply voltage terminal and a second power supply voltage terminal;
a first transistor connected between the first power supply voltage terminal and the light emitting element;
a second transistor connected between a data line and a first node;
a storage capacitor connected between the first node and a gate terminal of the first transistor; and
a holding capacitor connected between the first node and an anode initialization voltage terminal.

2. The pixel of claim 1, wherein the second transistor is configured to be turned on or off according to a write scan signal.

3. The pixel of claim 1, further comprising:
a third transistor connected between a drain terminal of the first transistor and a first terminal of the storage capacitor and configured to be turned on or off according to a compensation scan signal; and
a fourth transistor connected between the first node and a reference voltage terminal and configured to be turned on or off according to the compensation scan signal.

4. The pixel of claim 1, further comprising a fifth transistor connected between the first power supply voltage terminal and the first transistor and configured to be turned on or off according to an emission control signal.

5. The pixel of claim 3, wherein
the compensation scan signal applied to the third transistor and the fourth transistor is an n-th compensation scan signal, and
the pixel further comprises a sixth transistor connected between the first power supply voltage terminal and the first terminal of the storage capacitor and configured to be turned on or off according to a (n-k)-th compensation scan signal.

6. The pixel of claim 5, wherein a compensation period is adjusted based on a value of k.

7. The pixel of claim 1, further comprising
a seventh transistor connected between an anode of the light emitting element and the anode initialization voltage terminal and configured to be turned on or off according to an initialization scan signal.

8. The pixel of claim 7, wherein during a first period, the seventh transistor is configured to be turned on and an anode initialization voltage is configured to be applied to the anode of the light emitting element.

9. The pixel of claim 6, wherein during a first period, the sixth transistor is configured to be turned on and a first power supply voltage is configured to be applied to the gate terminal of the first transistor.

10. The pixel of claim 4, wherein during a second period, the third transistor and the fourth transistor are configured to be turned on, a first power supply voltage is configured to be applied to a drain terminal of the first transistor, and a reference voltage is configured to be applied to the first node.

11. A display device comprising:
a display unit comprising a plurality of pixels;
a scan driver configured to supply a corresponding scan signal to each of the plurality of pixels through a plurality of scan lines;
an emission control driver configured to supply a corresponding emission control signal to each of the plurality of pixels through a plurality of emission control lines;
a data driver configured to supply a corresponding data voltage to each of the plurality of pixels through the plurality of data lines; and
a power supply configured to supply a first power supply voltage, a second power supply voltage, and an anode initialization voltage to each of the plurality of pixels,
wherein each of the plurality of pixels comprises
a light emitting element connected between a first power supply voltage terminal, to which the first power supply voltage is applied, and a second power supply voltage terminal, to which the second power supply voltage is applied;
a first transistor connected between the first power supply voltage terminal and the light emitting element;
a second transistor connected a corresponding data line and the first node;
a storage capacitor connected between the first node and a gate terminal of the first transistor; and
a holding capacitor connected between the first node and an anode initialization voltage terminal to which the anode initialization voltage is applied.

12. The display device of claim 11, wherein
the scan signal comprises a write scan signal, and
the second transistor is configured to be turned on or off according to the write scan signal.

13. The display device of claim 11, wherein
the scan signal comprises a compensation scan signal,
the power supply is configured to supply a reference voltage, and
each of the plurality of pixels further comprises:
a third transistor connected between a drain terminal of the first transistor and a first terminal of the storage capacitor and configured to be turned on or off according to the compensation scan signal; and
a fourth transistor connected between the first node and a reference voltage terminal, to which the reference voltage is applied, and configured to be turned on or off according to the compensation scan signal.

14. The display device of claim 11, wherein each of the plurality of pixels further comprises a fifth transistor connected between the first power supply voltage terminal and the first transistor and configured to be turned on or off according to the emission control signal.

15. The display device of claim 13, wherein
the compensation scan signal applied to the third transistor and the fourth transistor is an N-th compensation scan signal, and
each of the plurality of pixels further comprises a sixth transistor connected between the first power supply voltage terminal and the first terminal of the storage capacitor and configured to be turned on or off according to a (N-K)-th compensation scan signal, wherein a compensation period is adjusted based on a value of k.

16. The display device of claim 11, wherein
the scan signal comprises an initialization scan signal, and
each of the plurality of pixels further comprises a seventh transistor connected between an anode of the light emitting element and the anode initialization voltage terminal and configured to be turned on or off according to the initialization scan signal.

17. The display device of claim 16, wherein during a first period, the seventh transistor is turned on and the anode initialization voltage is configured to be applied to the anode of the light emitting element.

18. The display device of claim 15, wherein during a first period, the sixth transistor is configured to be turned on and the first power supply voltage is configured to be applied to the gate terminal of the first transistor.

19. The display device of claim 14, wherein
the power supply is configured to supply a reference voltage, and
during a second period, the third transistor and the fourth transistor are configured to be turned on, the first power supply voltage is configured to be applied to a drain terminal of the first transistor, and the reference voltage is configured to be applied to the first node.

20. An electronic device comprising:
a display device comprising:
a pixel comprising:
a light emitting element connected between a first power supply voltage terminal and a second power supply voltage terminal;
a first transistor connected between the first power supply voltage terminal and the light emitting element;
a second transistor connected between a data line and a first node;
a storage capacitor connected between the first node and a gate terminal of the first transistor; and
a holding capacitor connected between the first node and an anode initialization voltage terminal.
